(19) United States
(12) Patent Application Publication
(10) Pub. No.: US 2019/0132195 A1
(43) Pub. Date: May 2, 2019

(54) TERMINAL IDENTIFICATION SYSTEM, TERMINAL, AND SERVER

(71) Applicant: FUJITSU LIMITED, Kawasaki-shi (JP)

(72) Inventor: Akira Nakanishi, Yokohama (JP)

(73) Assignee: FUJITSU LIMITED, Kawasaki-shi (JP)

(21) Appl. No.: 16/171,404

(22) Filed: Oct. 26, 2018

(30) Foreign Application Priority Data
Nov. 1, 2017 (JP) 2017-211966

(51) Int. Cl. H04L 12/24; G06F 1/26; H04L 12/26

(52) U.S. Cl. CPC H04L 41/0677; H04L 43/0811; G06F 1/26

(57) ABSTRACT

A terminal includes a first processor to generate a first packet when an electric-power amount capable of being supplied by a first electric-power-supplier is equal to or larger than a first threshold value, and generate a second packet that indicates a survival of the terminal in which the electric-power consumed for transmission of the second packet is smaller than the electric-power consumed for transmission of the first packet when the electric-power amount capable of being supplied by the first electric-power-supplier is less than the first threshold value, and a server includes a second processor to execute a first processing corresponding to the first packet when the first packet is received, execute a second processing corresponding to survival of the terminal when the second packet is received, and detect a failure occurrence of the terminal when the first and second packets are not received for a predetermined time.

### CROSS-REFERENCE TO RELATED APPLICATION

This application is based upon and claims the benefit of priority of the prior Japanese Patent Application No. 2017-211966, filed on Nov. 1, 2017, the entire contents of which are incorporated herein by reference.

### FIELD

The embodiments discussed herein are related to a terminal identification system, a terminal, and a server.

### BACKGROUND

As an application example of Internet of things (IoT), for example, there is a sensor network in which devices each having a sensor and a communication function are provided at a plurality of locations. For example, in the sensor network, many IoT devices have no connection with other devices by cables for a communication or for an electric power so as to increase the degree of freedom of installation, so that many IoT devices may operate by batteries or electricity storage devices or may perform a wireless communication.

Related techniques are disclosed in, for example, Japanese Laid-open Patent Publication Nos. 2014-195230 and 2011-101326.

### SUMMARY

According to an aspect of the embodiments, a terminal identification system includes a terminal configured to include a first electric power supplier configured to store an electric power and supply the electric power into the terminal, a first memory, a first processor coupled to the first memory and the first processor configured to generate a first packet when an amount of the electric power capable of being supplied by the first electric power supplier is equal to or larger than a first threshold value, and generate a second packet that indicates a survival of the terminal in which the electric power consumed for transmission of the second packet is smaller than the electric power consumed for transmission of the first packet when the amount of the electric power capable of being supplied by the first electric power supplier is less than the first threshold value, and a transmitter configured to transmit one of the first packet and the second packet, and a server configured to include a receiver configured to receive one of the first packet and the second packet, a second memory, and a second processor coupled to the second memory and the second processor configured to execute a first processing corresponding to the first packet when the first packet is received, execute a second processing corresponding to survival of the terminal when the second packet is received, and detect a failure occurrence of the terminal when the first packet and the second packet are not received for a predetermined time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a system configuration of a terminal identification system according to a first embodiment;

FIG. 2 is a view illustrating an example of a hardware configuration of a terminal;

FIG. 3 is a graph illustrating an example of charging specifications of the terminal;

FIG. 4 is a view illustrating an example of a format of a data packet according to the first embodiment;

FIG. 5 illustrates an example of a format of an irregular packet according to the first embodiment;

FIG. 6 is an example of a flowchart of a process in a microprocessor of the terminal;

FIG. 7 is an example of a flowchart of a power-feeding controlling process of a power supply control circuit;

FIG. 8 is an example of a flowchart of a charging controlling process of the power supply control circuit;

FIG. 9 is an example of a graph indicating an example of a change in an electric power amount of the terminal by a control of transmission of a data packet and a transmission of an irregular packet in the case where a transmission request periodically occurs;

FIG. 10 is a view illustrating an example of a sequence of a transmission processing of a data packet in the terminal;

FIG. 11 is a view illustrating an example of a sequence of a transmission processing of an irregular packet in the terminal;

FIG. 12 is a view illustrating an example of a hardware configuration of a server; and

FIG. 13 is an example of a flowchart of a processing in the server.

### DESCRIPTION OF EMBODIMENTS

An IoT device operating by a battery or an electricity storage device may not be able to transmit data when, for example, a transmission electric power is insufficient. In a service using data transmitted from the IoT device, interruption of a data transmission from the IoT device is equivalent to a failure of the corresponding IoT device from the viewpoint of a receiving side. Thus, when data is not transmitted from the IoT device due to the insufficiency in an electric power, there is a high possibility that the quality of the service being provided may be deteriorated.

Hereinafter, in the present specification, an electric power supply device (electric power supplier) that encompasses primary and secondary batteries, and an electricity storage device is used.

Hereinafter, descriptions will be made on an embodiment of a technology that is capable of suppressing a quality deterioration of a service using a terminal to which an electric power is supplied by the electric power supply device, with reference to the accompanying drawings. The following configuration of the embodiment is exemplary, and the present disclosure is not limited to the configuration of the embodiment.

### First Embodiment

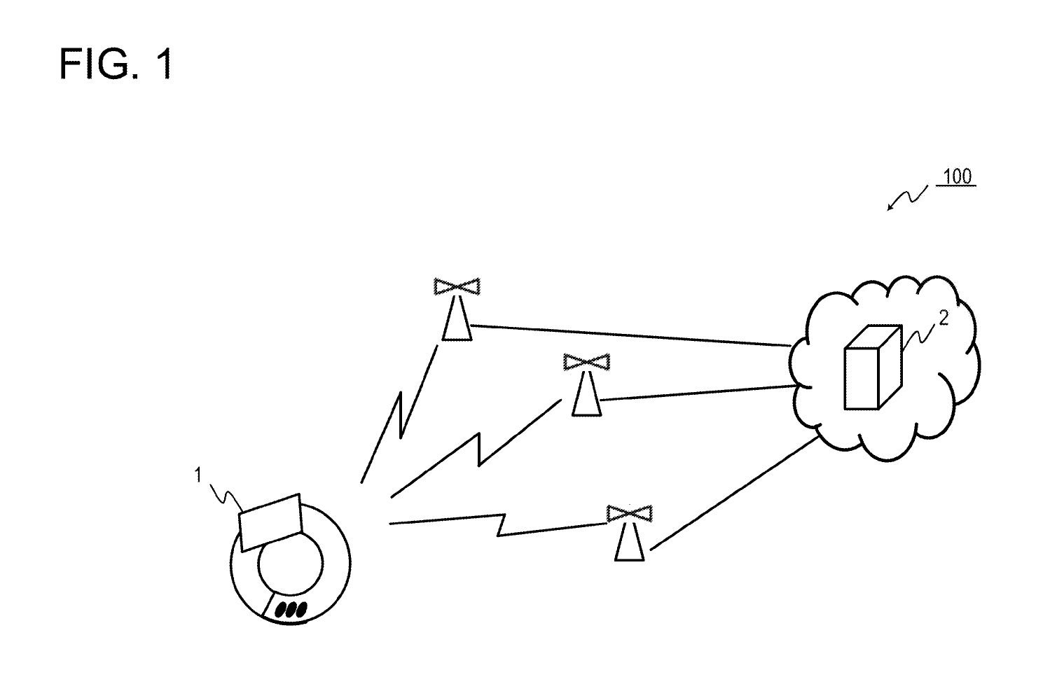

FIG. 1 is a view illustrating an example of a system configuration of a terminal identification system 100 according to a first embodiment. The terminal identification system 100 includes a plurality of terminals 1 and a server 2. Meanwhile, in the illustration in FIG. 1, one terminal 1 is extracted and represented for the sake of simplicity. The terminal 1 is an example of a “terminal.” The server 2 is an example of a “server.”

The terminal identification system 100 is a system for identifying the position of a person himself at the time of, for example, a disaster. The terminal 1 is, for example, a wristband-type or a pendant-type dedicated mobile terminal. The terminal 1 is distributed to an evacuee at, for example, a shelter, and is carried by the evacuee when, for example, an evacuation advisory is issued due to, for example, a disaster.

For example, in the terminal identification system 100, the terminal 1 transmits data to the server 2 and the server 2 performs a predetermined processing based on the data received from the terminal 1. The server 2 confirms survival of the terminal 1 by receiving the data from the terminal 1.

For example, a base station is present between the terminal 1 and the server 2. The base station relays the data sent from the terminal 1 through wireless communication, to the server 2. Communication using a service provided by, for example, SIGFOX may be performed between the terminal 1 and the server 2.

The terminal 1 includes, for example, a wireless communication function, a sensor capable of acquiring location information, and an energy harvesting device. The terminal 1 may be a general-purpose wearable terminal or a mobile terminal such as a smartphone.

The energy harvesting device is a device that obtains an electric power from an energy such as sunlight or illumination light, vibration generated by a machine, or heat. Since the terminal 1 is mounted with the energy harvesting device, a maintenance such as battery replacement becomes unnecessary. Thus, there is a possibility that an IoT device may be semi-permanently operated.

Meanwhile, since the power-feeding by the energy harvesting device depends on an environment, there is a possibility that a sufficient electric power may not be continuously supplied. For example, in the terminal 1, in order to stably secure an electric power, the electric power obtained by the energy harvesting device is stored in a capacitor. However, power-feeding by the energy harvesting device may depend on an environment, and then it may take time to perform charging from the energy harvesting device to the capacitor.

For example, in the case of SIGFOX, in order to suppress a re-transmission and reduce the power consumption, a transmission is executed three times consecutively for one data piece by changing the frequency. In the SIGFOX, the size of data that may be transmitted by one packet is 12 bytes. For example, in the case where data of 12 bytes is transmitted at 100 bps, it may take one hour or more to charge an electric power corresponding to power consumption by a solar cell.

Accordingly, even when, for example, the terminal 1 includes the energy harvesting device, there is a possibility that the transmitted electric power may be insufficient, and also there is a possibility that a service quality of the terminal identification system 100 may be deteriorated. However, the possibility that a service quality of the terminal identification system 100 may be deteriorated is not limited to a case where the terminal 1 includes the energy harvesting device, and may occur in a case where the terminal 1 independently operates by the electric power supply device.

In the first embodiment, when a transmission electric power is not insufficient, for example, the terminal 1 transmits a data packet including location information acquired by a sensor to the server 2. When a transmission electric power is insufficient, the terminal 1 transmits, for example, an irregular packet with a small size in order to indicate a survival of the own device. The irregular packet is smaller than the data packet in size, and thus a power consumption amount of the irregular packet is also smaller than that of the data packet according to transmission. Accordingly, the terminal 1 may transmit the packets to the server 2 for a longer time to make a notification of its survival. The data packet is an example of a “first packet.” The irregular packet is an example of a “second packet.”

[Terminal]

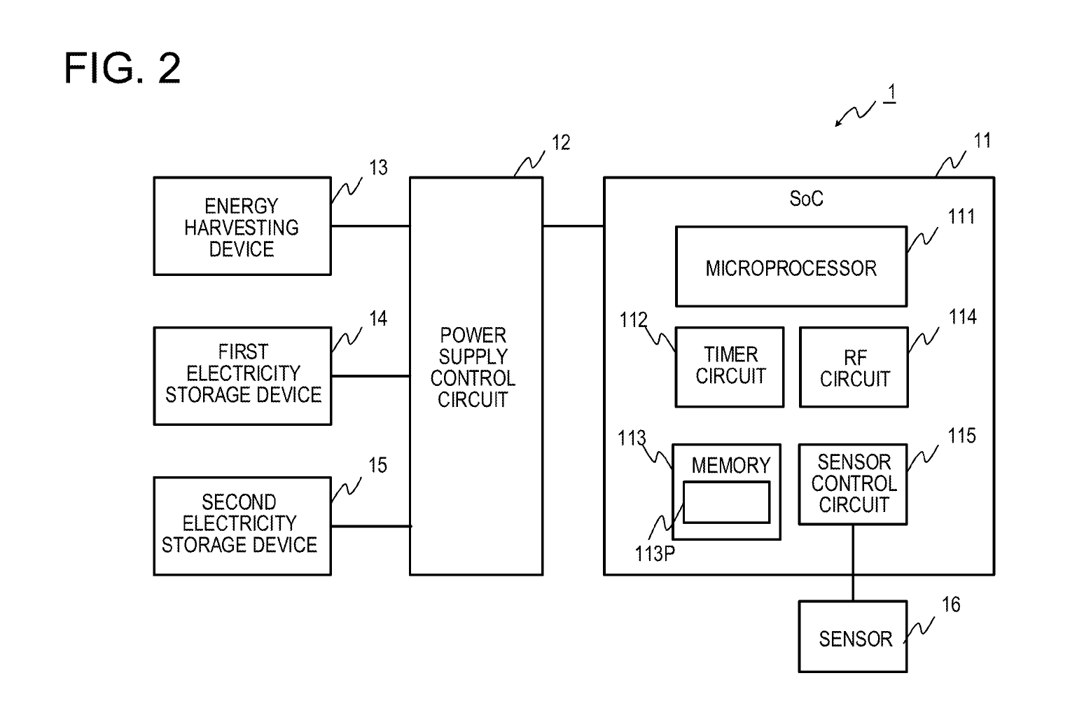

FIG. 2 is a view illustrating an example of a hardware configuration of the terminal 1. The terminal 1 includes, as hardware constituent elements, for example, a system on a chip (SoC) 11, a power supply control circuit 12, an energy harvesting device 13, a first electricity storage device 14, a second electricity storage device 15, and a sensor 16.

The SoC 11 includes a microprocessor 111, a timer circuit 112, a memory 113, a radio frequency (RF) circuit 114, and a sensor control circuit 115. The memory 113 includes a random access memory (RAM) and a read only memory (ROM). The RAM is, for example, a semiconductor memory such as a dynamic RAM (DRAM), a static RAM (SRAM), or a synchronous DRAM (SDRAM).

The memory 113 stores, for example, an operating system (OS), a data transmission program 113P, and other application programs therein. The data transmission program 113P is a program for transmitting data to the server 2. The memory 113 provides, for example, a storage area and a work area in which a program is to be loaded, to the microprocessor 111, or is utilized as a buffer. The data transmission program 113P is an example of an “information processing program.”

The microprocessor 111 executes various processings by executing the OS or the programs held in the memory 113, and controlling other hardware constituent elements. A plurality of microprocessors 111 may be provided. The terminal 1 may include a processor such as a central processing unit (CPU) or a field-programmable gate array (FPGA) instead of the microprocessor 111. The microprocessor 111 is an example of a “first controller.”

The timer circuit 112 includes, for example, a local clock, counts up or counts down the time of various timers, and transmits an interrupt request to the microprocessor 111 when the corresponding timer has expired. The RF circuit 114 performs a processing according to wireless communication, for example, a conversion of a wireless communication signal corresponding to a SIGFOX communication and an electric signal used within the terminal 1, and a frequency modulation. The RF circuit 114 is an example of a “transmitter.”

The sensor control circuit 115 controls the sensor 16. Specifically, the sensor control circuit 115 is activated when power-feeding from the power supply control circuit 12 is started, for example, at a predetermined cycle. Here, power-feeding to the sensor 16 is also started, and the sensor 16 is also activated. The sensor control circuit 115 stores data acquired by the sensor 16 in any one of, for example, the memory 113, a memory provided in the sensor control circuit 115, and memories other than these. For example, after a predetermined time has elapsed from activation of the sensor control circuit 115, power-feeding from the power supply control circuit 12 is stopped and an operation of the sensor control circuit 115 is stopped. Here, power-feeding to the sensor 16 is also stopped, and an operation of the sensor 16 is also stopped. A cycle at which the sensor control circuit 115 is activated is set in units of, for example, 1 min, 10 min, or one hour by a system manager.

The sensor 16 is, for example, a global positioning system (GPS) receiver. Meanwhile, the sensor 16 is not limited to a GPS receiver. For example, the sensor 16 only has to be a sensor capable of acquiring location information. When the terminal 1 is applied to other systems than the terminal identification system 100, the sensor 16 is not limited to a sensor capable of acquiring location information and may be, for example, a sensor for temperature, humidity, or acceleration. Hereinafter, a positioning value and a measurement value acquired by the sensor 16 will be collectively referred to as sensor data.

The energy harvesting device 13 is, for example, a solar cell, a thermocouple, a vibration power generation device, or a radio wave power generation device. Meanwhile, the energy harvesting device 13 is not limited to these, and may be any energy harvesting device. An electric power acquired by the energy harvesting device 13 is input to the power supply control circuit 12. The energy harvesting device 13 is an example of an “energy harvesting device.”

The first electricity storage device 14 and the second electricity storage device 15 are, for example, a capacitor, a super capacitor, and a secondary battery. The first electricity storage device 14 and the second electricity storage device 15 store an electric power acquired by the energy harvesting device 13, which is input from the power supply control circuit 12. It is assumed that the capacity of the first electricity storage device 14 is larger than that of the second electricity storage device 15. The first electricity storage device 14 is an example, of a “first electric power supply device (first electric power supplier)” or a “first electricity storage device.” The second electricity storage device 15 is an example of a “second electric power supply device (second electric power supplier)” or a “second electricity storage device.”

The power supply control circuit 12 controls the power-feeding to other hardware constituent elements. Specifically, the power supply control circuit 12 is mounted with, for example, a processor such as an FPGA, and a sequencer. The power supply control circuit 12 performs following processings. The power supply control circuit 12 is an example of a “control circuit.”

The power supply control circuit 12 stores an electric power fed from the energy harvesting device 13, in the first electricity storage device 14 or the second electricity storage device 15. The power supply control circuit 12 preferentially stores the electric power in, for example, the second electricity storage device 15. That is, the power supply control circuit 12 starts to store the electric power in the first electricity storage device 14 after the second electricity storage device 15 is fully charged.

The power supply control circuit 12 preferentially uses, for example, the first electricity storage device 14 in supplying of the electric power to other hardware constituent elements. The power supply control circuit 12 uses the second electricity storage device 15 when the electric power of the first electricity storage device 14 runs out.

The power supply control circuit 12 supplies an electric power to, for example, the microprocessor 111, the timer circuit 112, the memory 113, and the sensor control circuit 115. For example, the power supply control circuit 12 starts or stops supplying of an electric power to the RF circuit 114, according to an instruction from the microprocessor 111.

The power supply control circuit 12 includes, for example, a residual power meter using, for example, a coulomb counter, and manages residual electric power amounts of the first electricity storage device 14 and the second electricity storage device 15. For example, when receiving an inquiry from the microprocessor 111, the power supply control circuit 12 makes notification of the residual electric power amount of the first electricity storage device 14 or the second electricity storage device 15. The power supply control circuit 12 may notify the microprocessor 111 of a value of the residual electric power amount, or may notify the microprocessor 111 of a voltage value.

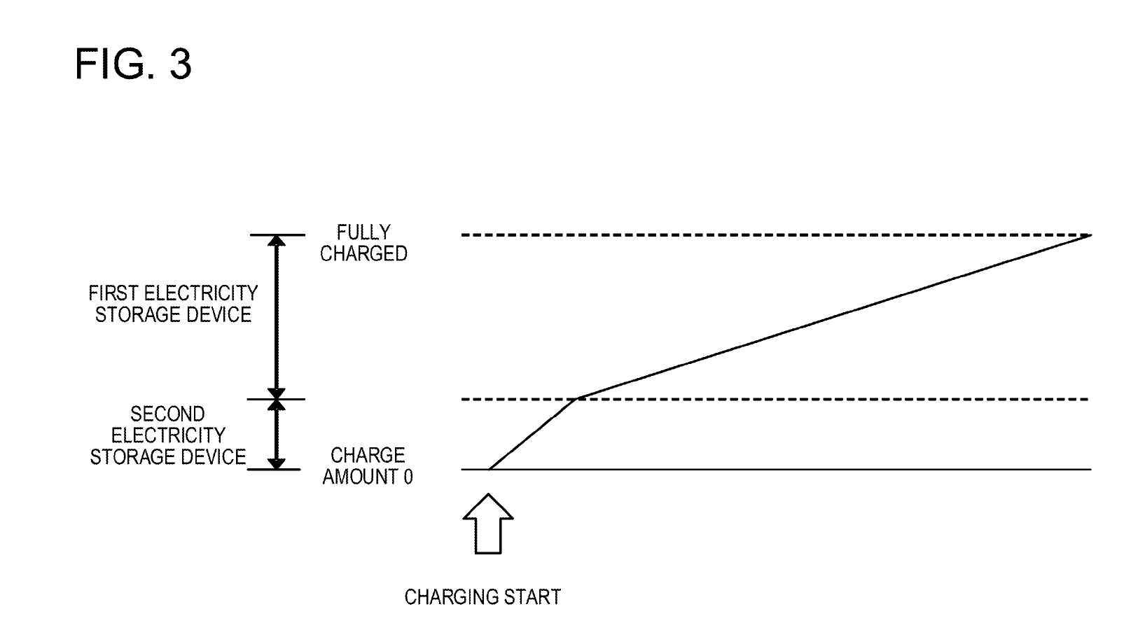

FIG. 3 is a graph illustrating an example of charging specifications of the terminal 1. In the graph illustrated in FIG. 3, the vertical axis indicates a charge amount of the terminal 1, and the horizontal axis indicates a time. Charging in the terminal 1 is started from the second electricity storage device 15. When the second electricity storage device 15 is fully charged, charging of the first electricity storage device 14 is started. Thus, the charge amount of the terminal 1 changes as in, for example, the graph illustrated in FIG. 3, when the charging is started from a charge amount 0.

It is possible to use a primary battery instead of the second electricity storage device 15. When the primary battery is used instead of the second electricity storage device 15, the terminal 1 has a charge amount corresponding to a capacity of the second electricity storage device 15 (the primary battery), even in the case where an amount of the electricity stored in the first electricity storage device 14 is 0. Thus, when the primary battery is used instead of the second electricity storage device 15, the graph of a change of the charge amount of the terminal 1 is started from a charge amount corresponding the capacity of the second electricity storage device 15 (the primary battery), at the time point of the start of charging. The electric power capacity of the second electricity storage device 15 is an electric power amount by which, for example, an irregular packet may be transmitted a predetermined number of times.

Next, the microprocessor 111 executes the data transmission program 113P to perform, for example, a following processing. When a transmission request of data occurs, the microprocessor 111 acquires a residual electric power amount of the first electricity storage device 14 from the power supply control circuit 12, and determines whether the residual electric power amount of the first electricity storage device 14 is sufficient for data transmission.

When the residual electric power amount of the first electricity storage device 14 is sufficient for data transmission, the microprocessor 111 generates a normal data packet, and transmits the normal data packet to the server 2 via the RF circuit 114. When the residual electric power amount of the first electricity storage device 14 is not sufficient for data transmission, the microprocessor 111 generates an irregular packet, and transmits the irregular packet to the server 2 via the RF circuit 114.

The transmission request of data occurs, for example, periodically, or by any one of an occurrence of an internal event, an occurrence of an external event, and a request from the server 2. In the case where the data transmission request periodically occurs, for example, a timer with a predetermined time length is set in the timer circuit 112. Then, when the corresponding timer expires, the timer circuit 112 triggers the microprocessor 111 by an interrupt request. A cycle at which the data transmission request occurs is set in units of, for example, 10 min or one hour by, for example, a system manager.

In the case where the occurrence of the data transmission request is triggered by the occurrence of the internal event, the internal event is, for example, an event occurring by an action of constituent elements provided in the terminal 1. The internal event includes, for example, that positioning data by the sensor 16 (e.g., a GPS) has reached a predetermined point, or that the fact that a value measured by the sensor 16 (e.g., a temperature sensor) exceeds a predetermined threshold value is indicated. In the case where the occurrence of the data transmission request is triggered by the occurrence of the external event, the external event is, for example, an event occurring by an action from the outside of the terminal 1 such as pressing on a switch provided in the terminal 1.

When the data transmission request occurs according to a request from the server 2, the terminal 1 activates the RF circuit 114 at a predetermined cycle so that a reception state is made for a predetermined time. The server 2 transmits the data transmission request at a predetermined cycle, so that the terminal 1 may receive the data transmission request within a period during which the reception state is made. In the terminal 1, a data transmission request occurs, which is triggered by, for example, reception of the transmission request from the server 2. For example, the transmission cycle of the data transmission request of the server 2 is equal to or less than the cycle at which the terminal 1 is in the reception state.

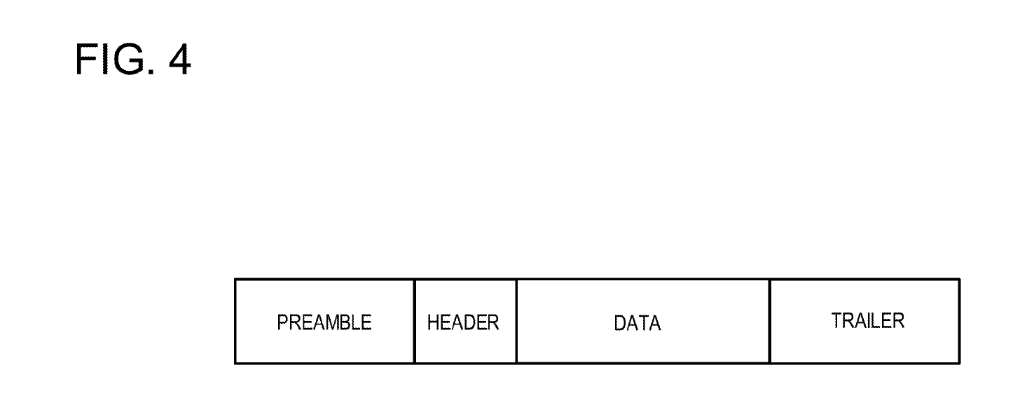

FIG. 4 is a view illustrating an example of a format of a data packet according to the first embodiment. The data packet includes a preamble, a header, data, and a trailer. The size of a data portion of the packet is, for example, 12 bytes. However, the data portion size is not limited to 12 bytes.

The header includes, for example, not only an address used for communication such as a destination address or a transmission source address, but also identification information of the terminal 1. As the identification information of the terminal 1, for example, any one of an address used for a communication, an identification number peculiar to a terminal, and a coded address or a coded identification number peculiar to a terminal is used. As data of the data packet, for example, sensor data acquired by the sensor 16 is stored.

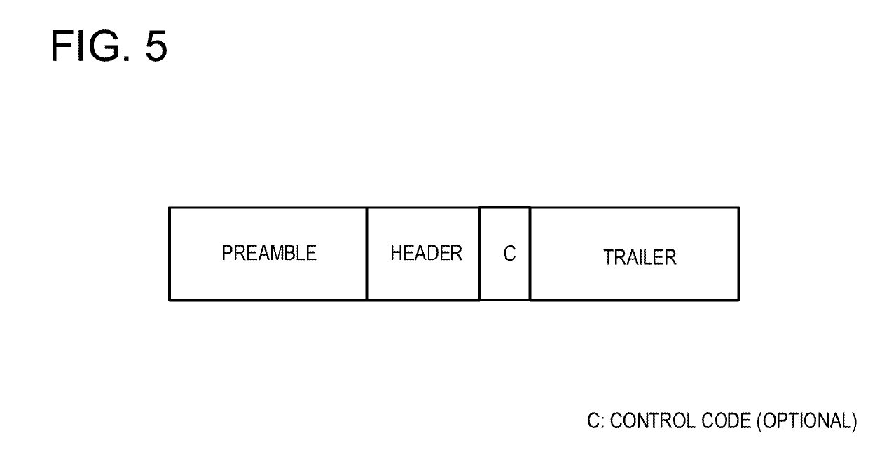

FIG. 5 illustrates an example of a format of an irregular packet according to the first embodiment. The irregular packet includes a preamble, a header, a control code, and a trailer. The header of the irregular packet has the same format as the data packet, and includes identification information of the terminal 1. All the identification information of the terminal 1, and an address used for communication, an identification number peculiar to a terminal, and a coded address or a coded identification number peculiar to a terminal, which are used as the identification information of the terminal 1, are examples of “terminal identification information.”

The control code is optional, and may not be included in the irregular packet. The control code includes, for example, a coded one of an expected recovery time of the terminal 1. Accordingly, the size of the control code is, for example, one byte and is smaller than the size of the data of the data packet (12 bytes). The identification of the data packet and the irregular packet is performed by, for example, a data size. Otherwise, for example, a code or a flag indicating that the packet is an irregular packet may be stored in, for example, the header of the irregular packet.

In the case of SIGFOX, when one data piece is transmitted, transmission is performed three times consecutively. Accordingly, in the first embodiment, when transmitting one data packet, the terminal 1 transmits the same packet three times consecutively. Meanwhile, in the first embodiment, when transmitting the irregular packet, the terminal 1 performs transmission a smaller number of times, as compared to the data packet. For example, when transmitting one irregular packet, the terminal 1 transmits the irregular packet once or twice consecutively.

Since the data size of the irregular packet is smaller than that of the data packet, a transmission electric power of the irregular packet becomes smaller than a transmission electric power of the data packet. Since the number of transmissions per irregular packet is smaller than the number of transmissions per data packet, the irregular packet has a smaller transmission electric power per packet. Accordingly, when an electric power of the first electricity storage device 14 is smaller than the transmission electric power per data packet, since switching to transmission of the irregular packet is made, it is possible to secure a longer time during which the terminal 1 may transmit packets.

In the terminal 1, a transmission cycle of the irregular packet may set to be longer than that of the data packet. Accordingly, power consumption of the terminal 1 may be reduced, and a longer time during which the terminal 1 may transmit packets may be secured.

Formats of the data packet and the irregular packet are not limited to those illustrated in FIGS. 4 and 5, and change depending on an employed communication standard. The irregular packet may have the same format as the data packet. In this case, the number of transmissions for one irregular packet becomes smaller than that for the data packet. That is, any one of the irregular packet having a smaller size than the data packet, the irregular packet that is transmitted a smaller number of times than the data packet, and the irregular packet having a longer transmission cycle than the data packet may be realized.

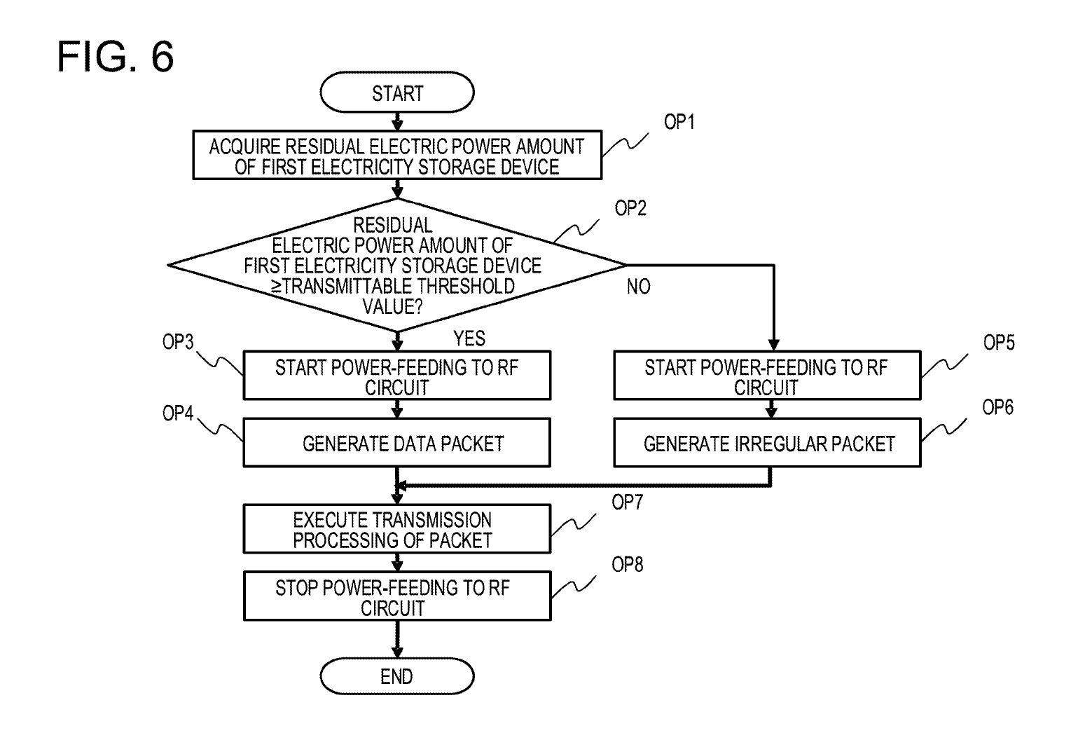

FIG. 6 is an example of a flowchart of a process in the microprocessor 111 of the terminal 1. The process illustrated in FIG. 6 is a process performed when the microprocessor 111 executes the data transmission program 113P. The process illustrated in FIG. 6 is started when, for example, a data transmission request occurs.

In OP1, the microprocessor 111 inquires of, for example, the power supply control circuit 12 about a residual electric power amount of the first electricity storage device 14, and acquires the residual electric power amount of the first electricity storage device 14. In OP2, the microprocessor 111 determines whether the residual electric power amount of the first electricity storage device 14 is equal to or larger than a transmittable threshold value. The transmittable threshold value is a value of an electric power amount+α, which is required for a transmission processing (the same data packet is transmitted three times) performed for one data piece in the case of, for example, SIGFOX. The transmittable threshold value is an example of a “first threshold value.” When the power supply control circuit 12 makes a notification of a voltage value of the first electricity storage device 14, the transmittable threshold value becomes a voltage value.

When the residual electric power amount of the first electricity storage device 14 is equal to or larger than the transmittable threshold value (OP2: YES), the process proceeds to OP3. When the residual electric power amount of the first electricity storage device 14 is less than the transmittable threshold value (OP2: NO), the process proceeds to OP5.

OP3 and OP5 are processings having the same contents. In OP3 and OP5, the microprocessor 111 instructs the power supply control circuit 12 to start power-feeding to the RF circuit 114. Thereafter, the power-feeding to the RF circuit 114 is started, and the RF circuit 114 is activated. In OP3, the power-feeding to the RF circuit 114 is performed from the first electricity storage device 14. In OP5, the power-feeding to the RF circuit 114 is performed from the first electricity storage device 14 in the case where the residual electric power amount of the first electricity storage device 14 is not 0, and is performed from the second electricity storage device 15 in the case where the residual electric power amount of the first electricity storage device 14 is 0.

In OP4, since the residual electric power amount of the first electricity storage device 14 is equal to or larger than the transmittable threshold value, the microprocessor 111 generates a data packet. The data packet includes, for example, sensor data of the sensor 16. For example, in the case where the sensor data is stored in a memory provided within the sensor control circuit 115, at the time of generation of the data packet, the microprocessor 111 transmits an acquisition request to the sensor control circuit 115 to acquire the sensor data of the sensor 16. For example, in the case where the sensor data is stored in a memory accessible by the microprocessor 111, at the time of generation of the data packet, the microprocessor 111 reads the sensor data from the corresponding memory to acquire the sensor data of the sensor 16.

In OP6, since the residual electric power amount of the first electricity storage device 14 is less than the transmittable threshold value, the microprocessor 111 generates an irregular packet.

In OP7, the microprocessor 111 executes a transmission processing on the packet generated in OP4 or OP6. In the transmission processing, for example, one packet is transmitted a predetermined number of times via the RF circuit 114. For example, in the case of SIGFOX, the data packet is transmitted three times, and the irregular packet is transmitted once or twice.

In OP8, since the transmission processing is completed, the microprocessor 111 instructs the power supply control circuit 12 to stop the power-feeding to the RF circuit 114. Accordingly, the power-feeding to the RF circuit 114 is stopped, and an operation of the RF circuit 114 is also stopped. Thereafter, the process illustrated in FIG. 6 is ended.

The process illustrated in FIG. 6 is an example, and a process of the terminal 1 is not limited to the process illustrated in FIG. 6.

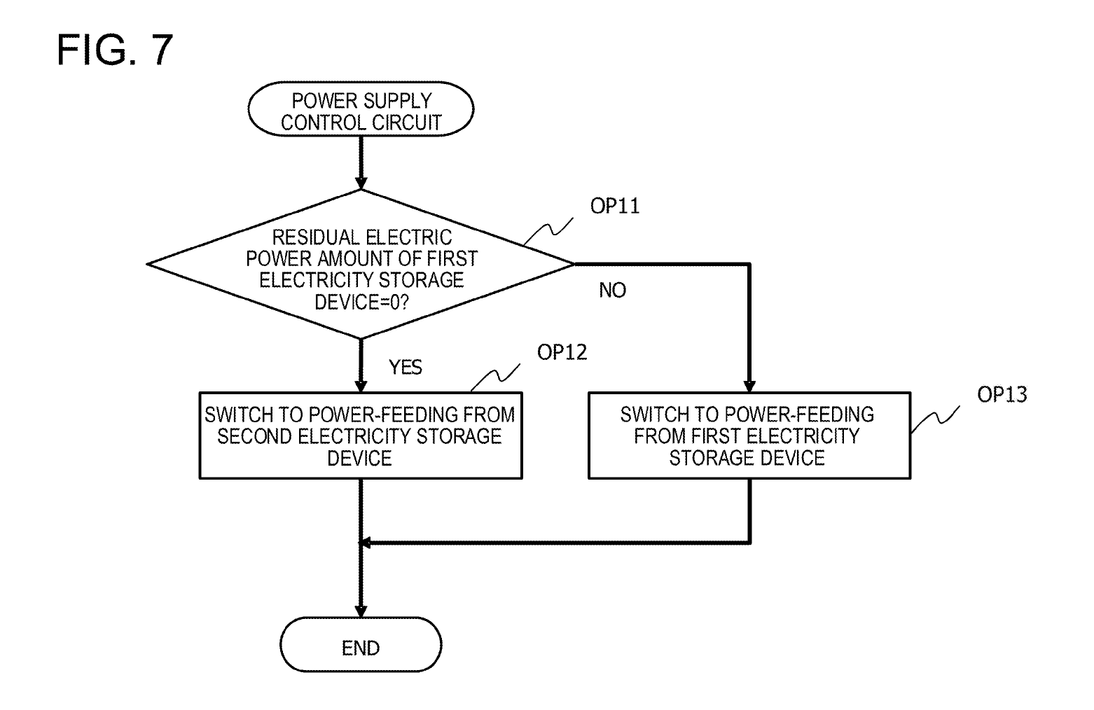

FIG. 7 is an example of a flowchart of a power-feeding controlling process of the power supply control circuit 12. The power-feeding controlling process is a process of determining which one of the first electricity storage device 14 and the second electricity storage device 15 to use in power-feeding to other devices. The process illustrated in FIG. 7 is executed by a processor (e.g., the FPGA) provided in the power supply control circuit 12. The process illustrated in FIG. 7 is repeatedly executed at a predetermined cycle, for example, during an operation of the terminal 1.

In OP11, the power supply control circuit 12 determines whether a residual electric power amount of the first electricity storage device 14 is 0. In OP11, a threshold value of the residual electric power amount of the first electricity storage device 14 is not limited to 0, and may be, for example, a value close to 0. The threshold value of the residual electric power amount of the first electricity storage device 14 is an example of a “second threshold value.”

When it is determined that the residual electric power amount of the first electricity storage device 14 is 0 (OP11: “YES”), the process proceeds to OP12. In OP12, the power supply control circuit 12 performs power-feeding to other devices from the second electricity storage device 15.

For example, when power-feeding is performed from the first electricity storage device 14, the power supply control circuit 12 performs switching to power-feeding from the second electricity storage device 15. For example, when power-feeding is performed from the second electricity storage device 15, the power supply control circuit 12 keeps the power-feeding from the second electricity storage device 15.

When it is determined that the residual electric power amount of the first electricity storage device 14 is not 0 (OP11: “NO”), the process proceeds to OP13. In OP13, the power supply control circuit 12 performs power-feeding to other devices from the first electricity storage device 14.

For example, when power-feeding is performed from the second electricity storage device 15, the power supply control circuit 12 performs switching to power-feeding from the first electricity storage device 14. For example, when power-feeding is performed from the first electricity storage device 14, the power supply control circuit 12 keeps the power-feeding from the first electricity storage device 14.

The power-feeding controlling process illustrated in FIG. 7 is an example, and the power-feeding controlling process is not limited to the process illustrated in FIG. 7. The threshold value of the residual electric power amount of the first electricity storage device 14 used in OP11 may not be 0, and may be, for example, a value close to 0, which is smaller than the transmittable threshold value.

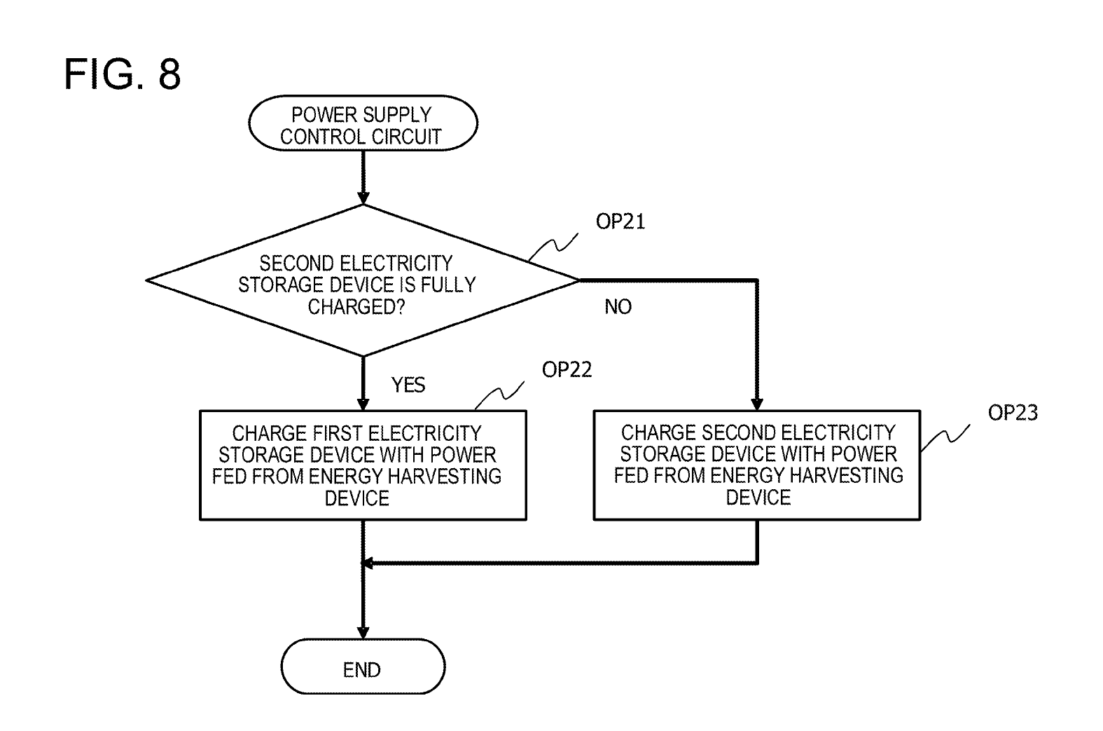

FIG. 8 is an example of a flowchart of a charging controlling process of the power supply control circuit 12. The charging controlling process is a process of determining which one of the first electricity storage device 14 and the second electricity storage device 15 to charge with an electric power generated by the energy harvesting device 13. The process illustrated in FIG. 8 is executed by a processor (for example, the FPGA) provided in the power supply control circuit 12. The process illustrated in FIG. 8 is repeatedly executed at a predetermined cycle, for example, during an operation of the terminal 1.

In OP21, the power supply control circuit 12 determines whether the second electricity storage device 15 is fully charged. When it is determined that the second electricity storage device 15 is fully charged (OP21: “YES”), the process proceeds to OP22. In OP22, the power supply control circuit 12 charges the first electricity storage device 14 with an electric power from the energy harvesting device 13.

When it is determined that the second electricity storage device 15 is not fully charged (OP21: “NO”), the process proceeds to OP23. In OP23, the power supply control circuit 12 charges the second electricity storage device 15 with the electric power from the energy harvesting device 13. Accordingly, charging of the second electricity storage device 15 is prioritized over the first electricity storage device 14.

The power-feeding controlling process illustrated in FIG. 8 is an example, and the charging controlling process is not limited to the process illustrated in FIG. 8. In the power-feeding controlling process illustrated in FIG. 7 and the power-feeding controlling process illustrated in FIG. 8, for example, the microprocessor 111 may execute the determination processing (OP11 in FIG. 7, OP21 in FIG. 8) to give an instruction to the power supply control circuit 12.

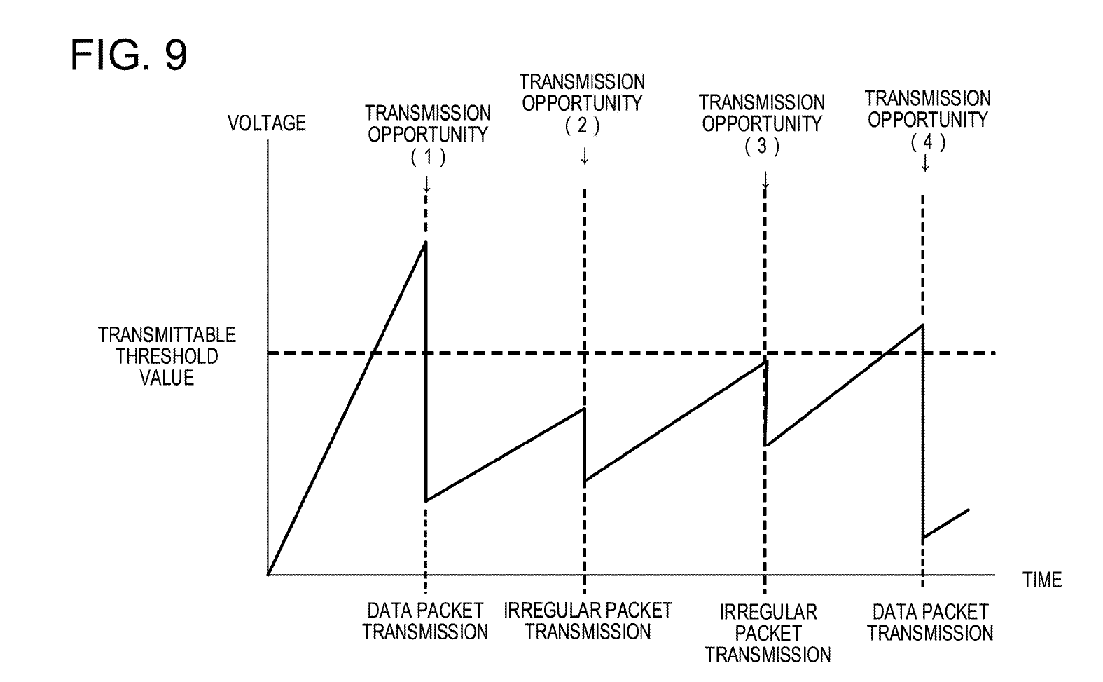

FIG. 9 is an example of a graph indicating an example of a change in an electric power amount of the terminal 1 by a control of transmission of a data packet and transmission of an irregular packet in the case where a transmission request periodically occurs. In the graph illustrated in FIG. 9, the vertical axis indicates a residual electric power amount of the first electricity storage device 14, and the horizontal axis indicates time.

It is assumed that between the time point of starting and the transmission opportunity (1), a charge amount of the first electricity storage device 14 is large due to, for example, strong sunshine. Thus, at the transmission opportunity (1) illustrated in FIG. 9, since a residual electric power amount of the first electricity storage device 14 is equal to or larger than a transmittable threshold value, a data packet is transmitted. Accordingly, the residual electric power amount of the first electricity storage device 14 decreases by an amount corresponding to a transmission processing of the data packet.

It is assumed that between the transmission opportunity (1) and the transmission opportunity (2) illustrated in FIG. 9, the charge amount of the first electricity storage device 14 is small due to, for example, weak sunshine. Thus, at the transmission opportunity (2) illustrated in FIG. 9, since the residual electric power amount of the first electricity storage device 14 is smaller than the transmittable threshold value, an irregular packet is transmitted. Accordingly, the residual electric power amount of the first electricity storage device 14 decreases by an amount corresponding to a transmission processing of the irregular packet.

Here, an electric power amount consumed by the transmission processing of the irregular packet is small as compared to the data packet. Thus, at the time point of the transmission opportunity (2), the electric power of the first electricity storage device 14 is not completely used and left.

Also, it is assumed that between the transmission opportunity (2) and the transmission opportunity (4) illustrated in FIG. 9, the charge amount of the first electricity storage device 14 is small due to, for example, weak sunshine. Meanwhile, at the transmission opportunity (4), since the residual electric power amount of the first electricity storage device 14 becomes larger than the transmittable threshold value, the data packet is transmitted again.

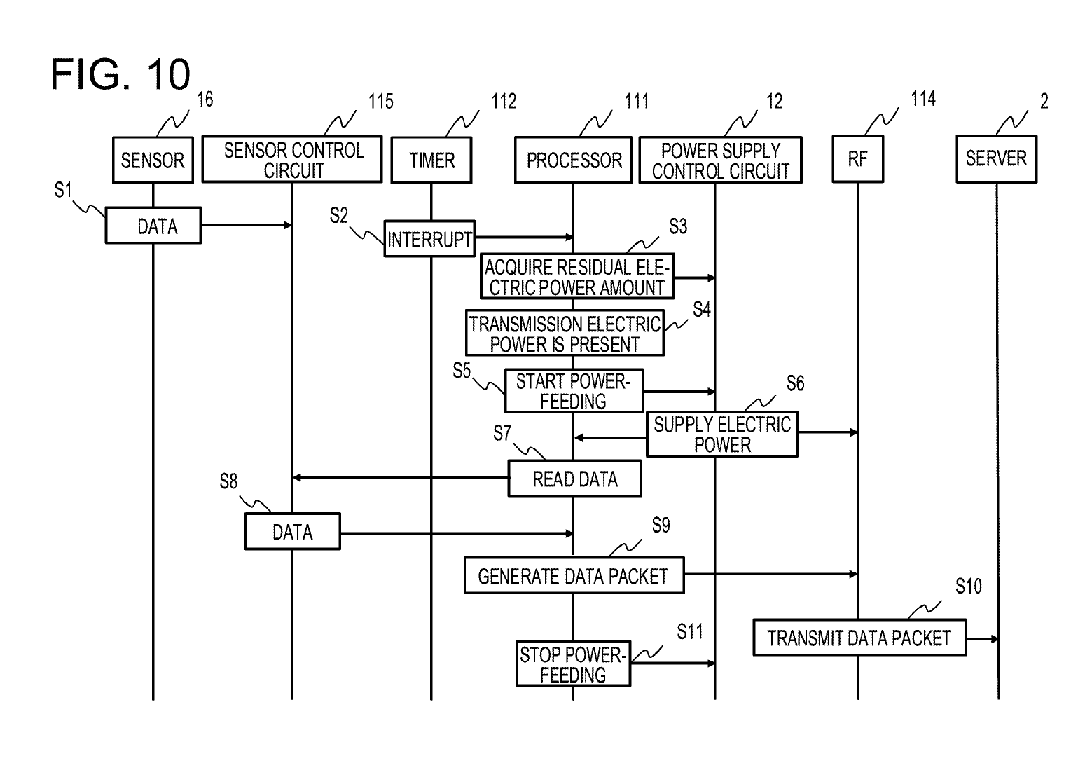

FIG. 10 is a view illustrating an example of a sequence of a transmission processing of a data packet in the terminal 1. In the example illustrated in FIG. 10, it is assumed that a transmission request periodically occurs. FIG. 10 is, for example, a processing sequence occurring at the transmission opportunities (1) and (4) in FIG. 9.

In S1, the sensor 16 is activated, for example, at a measurement timing, acquires sensor data, and outputs the sensor data to the sensor control circuit 115. In the example illustrated in FIG. 10, it is assumed that the sensor data is recorded in, for example, a memory within the sensor control circuit 115. Meanwhile, a storage location of the sensor data is not limited to the memory within the sensor control circuit 115. Then, when an electric power supply is stopped, for example, operations of the sensor control circuit 115 and the sensor 16 are stopped.

In S2, at an occurrence timing of a transmission request, an interrupt request is input from the timer circuit 112 to the microprocessor 111. In S3, the microprocessor 111 acquires a residual electric power amount of the first electricity storage device 14 from the power supply control circuit 12 (FIG. 6, OP1).

In S4, the microprocessor 111 determines that the residual electric power amount of the first electricity storage device 14 is equal to or larger than a transmission threshold value, and it is possible to transmit a data packet (FIG. 6, OP2: “YES”). In S5, the microprocessor 111 instructs the power supply control circuit 12 to start an electric power supply to the RF circuit 114 (FIG. 6, OP3). In S6, the power supply control circuit 12 supplies an electric power to the RF circuit 114.

In S7, the microprocessor 111 transmits a read request of the sensor data to, for example, the sensor control circuit 115. In S8, the sensor control circuit 115 outputs, for example, the sensor data acquired by the sensor 16 in S1 to the microprocessor 111.

In S9, the microprocessor 111 generates, for example, a data packet including the sensor data, and outputs the data packet to the RF circuit 114 (FIGS. 6, OP4 and OP7). In S10, the RF circuit 114 transmits the data packet to the server 2. Processings in S9 and S10 are performed, for example, three times.

In S11, the microprocessor 111 instructs the power supply control circuit 12 to stop power-feeding to the RF circuit 114 (FIG. 6, OP8). Accordingly, an operation of the RF circuit 114 is stopped.

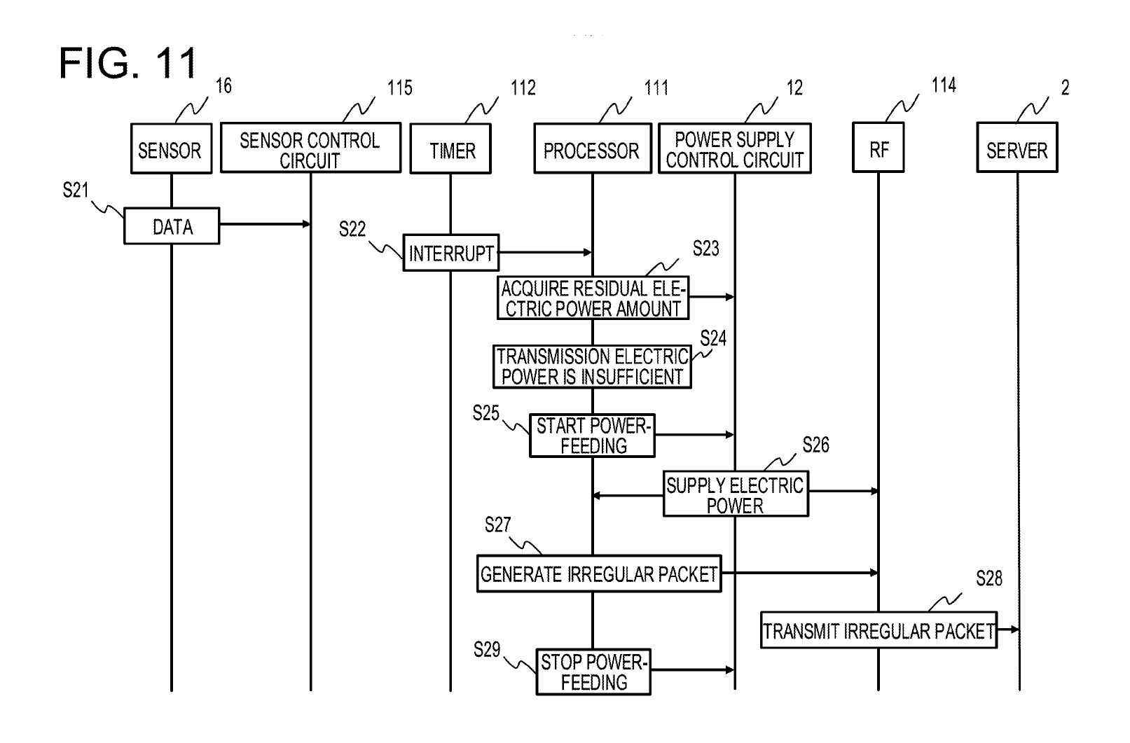

FIG. 11 is a view illustrating an example of a sequence of a transmission processing of an irregular packet in the terminal 1. In the example illustrated in FIG. 11, as in FIG. 10, it is assumed that a transmission request periodically occurs. FIG. 11 is, for example, a processing sequence occurring at the transmission opportunities (2) and (3) in FIG. 9.

In S21, the sensor 16 is activated, for example, at a measurement timing, acquires sensor data, and outputs the sensor data to the sensor control circuit 115. In the example illustrated in FIG. 11, it is assumed that the sensor data is recorded in, for example, a memory within the sensor control circuit 115.

In S22, at an occurrence timing of a transmission request, an interrupt request is input from the timer circuit 112 to the microprocessor 111. In S23, the microprocessor 111 acquires a residual electric power amount of the first electricity storage device 14 from the power supply control circuit 12 (FIG. 6, OP1).

In S24, the microprocessor 111 determines that the residual electric power amount of the first electricity storage device 14 is less than a transmission threshold value, and it is impossible to transmit a data packet (FIG. 6, OP2: “NO”). In S25, the microprocessor 111 instructs the power supply control circuit 12 to start an electric power supply to the RF circuit 114 (FIG. 6, OP5). In S26, the power supply control circuit 12 supplies an electric power to the RF circuit 114.

In S27, the microprocessor 111 generates an irregular packet, and outputs the irregular packet to the RF circuit 114 (FIGS. 6, OP6 and OP7). In S28, the RF circuit 114 transmits the irregular packet to the server 2. Processings in S9 and S10 are performed, for example, once or twice.

In S29, the microprocessor 111 instructs the power supply control circuit 12 to stop power-feeding to the RF circuit 114 (FIG. 6, OP8). Accordingly, an operation of the RF circuit 114 is stopped.

[Server]

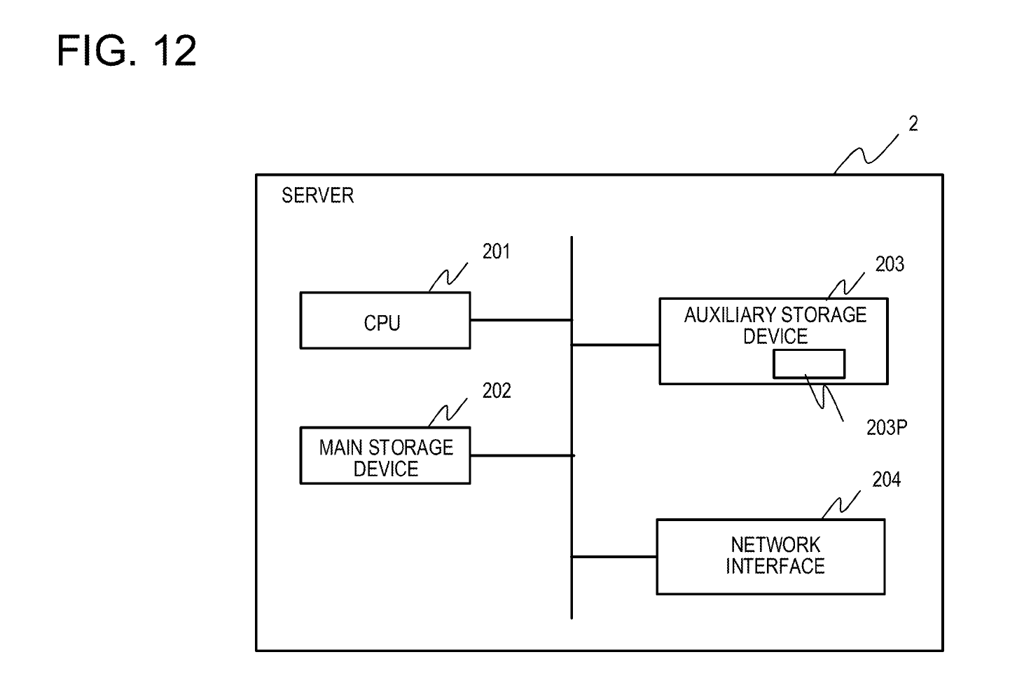

FIG. 12 is a view illustrating an example of a hardware configuration of the server 2. The server 2 is, for example, a dedicated computer, or a general-purpose computer. The server 2 includes, as hardware constituent elements, a CPU 201, a main storage device 202, an auxiliary storage device 203, and a network interface 204, which are electrically connected to each other via a bus.

The auxiliary storage device 203 is, for example, a non-volatile storage medium such as an erasable programmable ROM (EPROM) or a hard disk drive. The auxiliary storage device 203 stores, for example, an operating system (OS), a terminal identification program 203P, and other application programs therein. The terminal identification program 203P is a program for confirming survival of a terminal based on a packet received from the terminal 1. The terminal identification program 203P is an example of an “information processing apparatus.”

The main storage device 202 includes, for example, a RAM and a ROM. The RAM is, for example, a semiconductor memory such as a dynamic RAM (DRAM), a static RAM (SRAM), or a synchronous DRAM (SDRAM). The RAM of the main storage device 202 provides a storage area and a work area in which a program stored in the ROM or the auxiliary storage device 203 is to be loaded, to the CPU 201, or is utilized as a buffer.

The CPU 201 executes various processings by loading the OS or the program held in the auxiliary storage device 203 into the RAM and executing the OS or the program. A plurality of CPUs 201 may be provided. The CPU 201 is an example of a “controller.”

The network interface 204 is an interface by which information is input/output to/from a network. The network interface 204 is an interface connected to a wired network. The network interface 204 may include an interface connected to a wireless network. The network interface 204 is, for example, a network interface card (NIC), or a wireless local area network (LAN) card. For example, data received by the network interface 204 is output to the CPU 201. The network interface 204 is an example of a “receiver.”

The hardware configuration of the server 2 illustrated in FIG. 12 is an example, and is not limited to the above description. Then, omission, substitution, or addition of constituent elements may be properly made according to exemplary embodiments. For example, the server 2 may include a portable recording medium driving device, and may use a portable recording medium such as an SD card, as one of auxiliary storage devices.

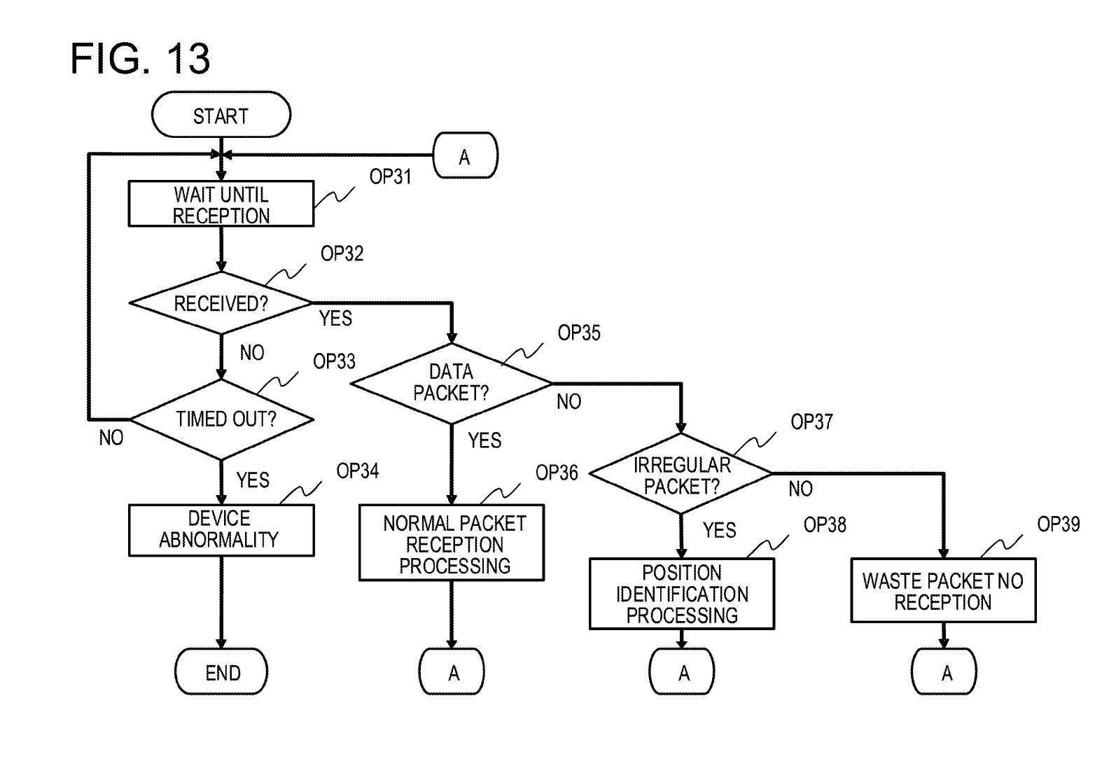

FIG. 13 is an example of a flowchart of a processing in the server 2. The processing described for the server 2 is a processing performed when the CPU 201 executes the terminal identification program 203P. The processing illustrated in FIG. 13 is started or stopped when, for example, an instruction is input from a system manager. In the server 2, for each of the terminals 1, a process of the processing illustrated in FIG. 13 is created.

In OP31, the CPU 201 waits until a packet is received from the terminal 1. For example, in the case where a data transmission request periodically occurs in the terminal 1, in OP31, the CPU 201 waits for the same time as an occurrence cycle of the data transmission request in the terminal 1.

In OP32, the CPU 201 determines whether the packet has been received from the terminal 1. The determination that the packet has been transmitted from the terminal 1, is identified by terminal identification information within, for example, a header of the received packet.

When it is determined that the packet has not been received from the terminal 1 (OP32: “NO”), the process proceeds to OP33. In OP33, the CPU 201 determines whether a device malfunction timer has timed out. The device malfunction timer is a timer with a time longer than, for example, a reception waiting time in OP31. When it is determined that the device malfunction timer has timed out (OP33: “YES”), the process proceeds to OP34.

In OP34, the CPU 201 determines that an abnormality occurs in the terminal 1. For example, the CPU 201 may notify a predetermined device of the device abnormality of the terminal 1. Then, the process illustrated in FIG. 13 is ended.

Meanwhile, when it is determined that the packet has been received from the terminal 1 (OP32: “YES”), the process proceeds to OP35. In the case where a plurality of base stations are present between the terminal 1 and the server 2, and the plurality of base stations receive signals from the terminal 1, a plurality of packets having the same contents may be received from the terminal 1. In the case of SIGFOX, since a transmission is performed three times for one data packet by changing a frequency, at least three data packets having the same contents are received from the terminal 1. Target packets in OP32 are packets received within a predetermined time from the time the first packet is received. The predetermined time is much shorter than, for example, the reception waiting time in OP31.

The CPU 201 determines a representative packet among the packets received from the terminal 1. When one packet is received from the terminal 1, the corresponding one packet is the representative packet.

When a plurality of packets having the same contents are received, the CPU 201 determines, for example, a packet received for the first time, or a packet having the largest reception signal strength, as the representative packet. The reception signal strength of a packet is added to the corresponding packet by, for example, a base station that has relayed the packet.

When a plurality of packets having different contents are received, the representative packet is selected from packets having contents which have been received the largest number of times.

In OP35, the CPU 201 determines whether the representative packet is a data packet. When it is determined that the representative packet is the data packet (OP35: “YES”), the process proceeds to OP36. In OP36, the CPU 201 performs a reception processing on a normal packet. In the reception processing on the normal packet, for example, a reception time of the data packet is recorded as survival confirmation of the terminal 1. In the case where the data packet includes location information by the sensor 16 (e.g., GPS), the CPU 201 records the location information of the terminal 1 in the main storage device 202. Then, the process proceeds to OP31. The processing in OP36 is an example of “a first processing corresponding to a first packet.”

When it is determined that the representative packet is not the data packet (OP35: “NO”), the process proceeds to OP37. In OP37, the CPU 201 determines whether the representative packet is an irregular packet.

When it is determined that the representative packet is the irregular packet (OP37: “YES”), the process proceeds to OP38. In OP38, the CPU 201 performs, for example, a position identification processing, and recording of a reception time of the irregular packet as survival confirmation of the terminal 1. The position identification processing is a processing of identifying the position of the terminal 1 based on the irregular packet. The position identification processing is performed, for example, as follows. The processing in OP38 is an example of “a second processing corresponding to survival of a terminal.”

In the case where a plurality of irregular packets having the same contents as the representative packet are present, the CPU 201 identifies the position of the terminal 1 from a reception signal strength of each of the plurality of corresponding irregular packets and a transmission electric power of the terminal 1. The distance between the terminal 1 and a base station that has relayed an irregular packet is obtained from the reception signal strength of the corresponding irregular packet and the transmission electric power of the terminal 1.

The transmission electric power of the terminal 1 may be included within, for example, a header of a data packet or an irregular packet, or may have already been known with a fixed output. Identification information of a base station that has relayed a packet is added to the corresponding packet together with a reception signal strength, for example, by the base station. The server 2 holds location information of each base station. Accordingly, when a plurality of irregular packets having the same contents as a representative packet are present, the position of the terminal 1 may be identified from a distance between each base station and the terminal 1 and location information of each base station.

More specifically, for one base station, there is a possibility that the terminal 1 may be present on a circumference whose radius is a distance obtained from a reception signal strength of an irregular packet and a transmission electric power of the terminal 1. The position of the terminal 1 is identified by combining circumferences obtained from distances between other base stations and the terminal 1, which are obtained from other irregular packets.

The CPU 201 records the identified position of the terminal 1 in the main storage device 202. Then, the process proceeds to OP31.

When it is determined that the representative packet is neither the data packet nor the irregular packet (OP37: “NO”), the process proceeds to OP39. In OP39, all the packets received in OP32 are wasted. Then, the process proceeds to OP31.

The processing illustrated in FIG. 13 is an example, and a processing of the server 2 is not limited to the processing illustrated in FIG. 13.

### Operation and Effect of First Embodiment

In the first embodiment, when a transmission electric power is insufficient for a data packet, the terminal 1 transmits an irregular packet in which an electric power consumed for transmission is small as compared to the data packet. Accordingly, the terminal 1 may transmit an irregular packet even in a situation where it is impossible to transmit a data packet, and survival of the terminal 1 may be confirmed for a longer time.

When receiving the irregular packet, the server 2 acquires location information of the terminal 1 based on the irregular packet. Accordingly, the server 2 may track the location information of the terminal 1 for a longer time.

The terminal 1 includes an energy harvesting device, and charges the first electricity storage device 14 and the second electricity storage device 15 with an electric power generated by the energy harvesting device. Accordingly, for example, a time for maintenance such as battery replacement may be omitted.

The terminal 1 includes the second electricity storage device 15, and uses the second electricity storage device 15 in the case where a residual electric power amount of the first electricity storage device 14 becomes 0. The terminal 1 preferentially charges the second electricity storage device 15. Accordingly, the terminal 1 may transmit an irregular packet for a longer time, and survival of the terminal 1 may be confirmed for a longer time. When the terminal 1 performs charging by electric power generation by the energy harvesting device, it is possible to more stably operate power-feeding by the energy harvesting device by providing the second electricity storage device 15.

[Others]

In the first embodiment, descriptions have been made on an example in which the terminal 1 includes the second electricity storage device 15, but the terminal 1 may not include the second electricity storage device 15. It is also possible to apply the technology described in the first embodiment to a case where the terminal 1 includes a primary battery instead of the first electricity storage device 14.

In the first embodiment, descriptions have been made on an example of a case where the terminal 1 corresponds to SIGFOX, but a communication method corresponding to the terminal 1 is not limited to SIGFOX. For example, the terminal 1 may be a terminal corresponding to Zigbee, or other communication methods.

[Processor]

In the above described exemplary embodiment, the server 2 includes a CPU, and executes an instruction expanded from a program within a main storage device, thereby executing the described process. The CPU is also called a microprocessor (MPU) or a processor. The CPU is not limited to a single processor, and may be configured as a multi-processor. A single CPU connected by a single socket may have a multicore configuration. A processing of at least a part of the above respective units may be performed by any processor other than the CPU, for example, a dedicated processor such as a digital signal processor (DSP), a graphics processing unit (GPU), a numerical operation processor, a vector processor, or an image processing processor. A processing of at least a part of the above respective units may be an integrated circuit (IC), or other digital circuits. At least a part of the above respective units may include an analogue circuit. The integrated circuit includes an LSI, an application specific integrated circuit (ASIC), or a programmable logic device (PLD). The PLD includes, for example, a field-programmable gate array (FPGA). Each of the above units may be a combination of a processor and an integrated circuit. The combination is called, for example, a microcontroller (MCU), a system-on-a-chip (SoC), a system LSI, or a chip set.

[Recording Medium]

A program, by which any one of the above functions may be realized in a computer, other machine, and a device (e.g., a computer hereinafter), may be recorded in a recording medium readable by, for example, the computer. The program in the recording medium may be read and executed on, for example, the computer so that the function may be provided.

Here, the recording medium readable by, for example, the computer refers to a non-transitory recording medium in which information such as data or programs is stored by an electrical, magnetic, optical, mechanical, or chemical action, and is readable by, for example, the computer. Among such recording media, examples of a medium detachable from, for example, the computer include a flexible disk, a magneto-optical disk, a CD-ROM, a CD-R/W, a DVD, a Blu-ray disk, a DAT, a 8 mm tape, a memory card such as a flash memory. Examples of a recording medium fixed to, for example, the computer include a hard disk and a read only memory (ROM). A solid state drive (SSD) may be used as a recording medium detachable from, for example, the computer, or as a recording medium fixed to, for example, the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal identification system comprising:
a terminal configured to include:
a first electric power supplier configured to store an electric power and supply the electric power into the terminal,
a first memory,
a first processor coupled to the first memory and the first processor configured to:
generate a first packet when an amount of the electric power capable of being supplied by the first electric power supplier is equal to or larger than a first threshold value, and
generate a second packet that indicates a survival of the terminal in which the electric power consumed for transmission of the second packet is smaller than the electric power consumed for transmission of the first packet when the amount of the electric power capable of being supplied by the first electric power supplier is less than the first threshold value, and
a transmitter configured to transmit one of the first packet and the second packet; and
a server configured to include:
a receiver configured to receive one of the first packet and the second packet,
a second memory, and
a second processor coupled to the second memory and the second processor configured to:
execute a first processing corresponding to the first packet when the first packet is received,
execute a second processing corresponding to survival of the terminal when the second packet is received, and
detect a failure occurrence of the terminal when the first packet and the second packet are not received for a predetermined time.

2. The terminal identification system according to claim 1,
wherein the terminal further includes:
a second electric power supplier, and
a control circuit configured to control the first electric power supplier and the second electric power supplier so as to switch an electric power supply source to the second electric power supplier when the amount of the electric power capable of being supplied by the first electric power supplier is equal to or less than a second threshold value lower than the first threshold value.

3. The terminal identification system according to claim 2,
wherein the terminal further includes an energy harvesting device,
wherein the first electric power supplier is a first electricity storage device, and
wherein the control circuit charges the first electricity storage device with an electric power generated by the energy harvesting device.

4. The terminal identification system according to claim 3,
wherein the second electric power supplier is a second electricity storage device, and
wherein the control circuit stores the electric power generated by the energy harvesting device, in the second electricity storage device in preference to the first electricity storage device.

5. The terminal identification system according to claim 1,
wherein the second processor is further configured to identify a position of the terminal, based on the second packet, as the second processing.

6. The terminal identification system according to claim 1,
wherein the second packet is at least any one of a packet having a smaller size than the first packet, a packet that is transmitted a smaller number of times than the first packet in one transmission processing, and a packet having a longer transmission cycle than the first packet.

7. A terminal comprising:
a first electric power supplier configured to store an electric power and supply the electric power into the terminal;
a memory;
a processor coupled to the memory and the processor configured to:
generate a first packet when an amount of the electric power capable of being supplied by the first electric power supplier is equal to or larger than a first threshold value, and
generate a second packet that indicates a survival of terminal in which the electric power consumed for transmission of the second packet is smaller than the electric power consumed for transmission of the first packet when the amount of the electric power capable of being supplied by the first electric power supplier is less than the first threshold value; and
a transmitter configured to transmit one of the first packet and the second packet.

8. A server comprising:
a receiver configured to receive one of a first packet and a second packet that indicates a survival of a terminal in which an electric power consumed for transmission of the second packet is smaller than the electric power consumed for transmission of the first packet, from the terminal;
a memory; and
a processor coupled to the memory and the processor configured to:
execute a first processing corresponding to the first packet when the first packet is received,
execute a second processing corresponding to the survival of the terminal when the second packet is received, and
detect a failure occurrence of the terminal when the first packet and the second packet are not received for a predetermined time.
